(19) United States
(12) Patent Application Publication
(10) Pub. No.: US 2023/0249562 A1
(43) Pub. Date: Aug. 10, 2023

(54) CHARGING STATION FOR HYBRID OR ELECTRIC VEHICLE

(71) Applicant: VALEO SYSTEMES DE CONTROLE MOTEUR, Cergy Pontoise (FR)

(72) Inventors: Maxime TANSORIER, Paris (FR); Samuel TORDEUX, Paris (FR); Sébastien FRAISE, Paris (FR)

(73) Assignee: VALEO SYSTEMES DE CONTROLE MOTEUR, Cergy Pontoise (FR)

(21) Appl. No.: 18/166,316

(22) Filed: Feb. 8, 2023

(30) Foreign Application Priority Data
Feb. 8, 2022 (FR) 22 01110

(51) Int. Cl. B60L 53/18; B60L 53/30

(52) U.S. Cl. CPC B60L 53/18; B60L 53/30

(57) ABSTRACT

Charging station for an electric or hybrid vehicle includes a wall, an electric cable, and at least one clamping collar fixed to the wall. The clamping collar has a shape that allows there to be, in a plane perpendicular to the direction in which the cable extends, at least three points of contact between the cable and the assembly formed by the clamping collar and the wall, so as to clamp the cable against the wall.

The present invention relates to a charging station for a hybrid or electric vehicle.

The vehicle has, for example, a battery intended to power an electric machine for the propulsion of the vehicle, this battery having a nominal voltage, the level of which may be 48V, or in excess of 60V, being, for example, higher than 200V or than 300V, or than 400V, or more 800V.

The station receives electrical power from an electrical network via a cable which, depending on the application, may be a single-phase cable or three-phase cable, and it therefore follows that there will be a difference in diameter between the cables. Moreover, even from one single-phase cable to another, the cable diameter may change according to the power being carried. The same is true from one three-phase cable to another, it being possible for these to have different diameters according to the power being carried.

It is necessary for the cable to be fixed robustly inside the station, for reasons of safety and of correct operation of the station. This robust fixing, given the aforementioned differences in diameter, requires several types of clamping collar, which is expensive and prevents the charging station from becoming further standardized.

There is a need to overcome the aforementioned disadvantages.

The invention meets this need, according to one of the aspects thereof, by means of a charging station for a hybrid or electric vehicle comprising:

a wall,

an electric cable, and

at least one clamping collar fixed to the wall,
characterized in that the clamping collar has a shape that allows there to be, in a plane perpendicular to the direction in which the cable extends, at least three points of contact between the cable and the assembly formed by the clamping collar and the wall, so as to clamp the cable against the wall.

According to the invention, the shape of the clamping collar allows there to be at least three points of contact between the cable and the assembly formed by the clamping collar and the wall. The presence of these three points of contact, which allow robust fixing, is thus ensured for different diameters of cable, for example for any cable of a diameter of between 5 mm and 30 mm, notably between 10 mm and 22 mm, notably between 10 mm and 19 mm. The one same clamping collar can thus be used for a plurality of cable diameters, thereby increasing the standard nature of the station.

The wall may have a curved surface for contact with the cable and the contour of the cable, in said plane perpendicular to the direction in which it extends, may be a circle. This wall, against which the cable is clamped by the clamping collar may define one of said points of contact between the cable and the assembly formed by the wall and the clamping collar, or may even form a plurality of points of contact with the cable. This wall is, for example, produced as one piece with part of the housing of the station, for example with the back frame of the station, which is the part of this housing that is furthest from the user when the latter is wishing to connect to the station. As a variant, this wall is distinct from the housing and attached thereto.

The clamping collar may have a portion which, in said plane perpendicular to the direction in which the cable extends, has the form of a broken line, this portion in the form of a broken line forming at least one point of contact, notably at least two points of contact, between the cable and the assembly formed by the clamping collar and the wall. In that case, at least one of the other, or even two of the other, said points of contact is formed by the wall.

The portion in the form of a broken line may comprise at least three vertices, namely successively a first vertex, a second vertex and a third vertex, the second vertex constituting a turning point for the portion in the form of a broken line. In other words, in the plane perpendicular to the direction in which the cable extends, the portion in the form of a broken line may be M-shaped or W-shaped depending on the direction in which this portion is observed. The portion in the form of a broken line notably comprises exactly three vertices.

This configuration of clamping collar makes it possible, in a simple way, to achieve the aforementioned three or more points of contact.

In such a case, the clamping collar may be positioned on the wall in such a way that the first vertex and the third vertex are at a distance from the cable that is greater than the distance between the second vertex and the cable. Two of the points of contact between the cable and the assembly formed by the clamping collar and the wall may be defined by segments of the broken line other than the segment connecting the second vertex to the first vertex and other than the segment connecting the second vertex to the third vertex. As a variant, the second vertex may define one of these points of contact. There are then one or more other points of contact at the wall.

In a variant, but still when there is a portion in the form of a broken line, the clamping collar may be positioned on the wall in such a way that the first vertex and the third vertex are at a distance from the cable that is smaller than the distance between the second vertex and the cable. Each of the first and third vertices may then define a point of contact between the cable and the assembly formed by the clamping collar and the wall, there then being one or more other points of contact at the wall. In this variant, and alternatively, the clamping collar still defines two points of contact with the cable, via, respectively, the segment connecting the second vertex to the first vertex, and the segment connecting the second vertex to the third vertex.

In all of the foregoing, the clamping collar may be fixed to the wall via at least two fastening members, each fastening member collaborating with a fixing zone of the clamping collar and, in said plane perpendicular to the direction in which the cable extends, the portion in the form of a broken line may be positioned between the two fixing zones. Each fastening member is, for example, a screw.

As already mentioned, the electric cable may be a three-phase or single-phase cable. The invention allows the same clamping collar to be used indifferently for fixing a three-phase cable or a single-phase cable to the wall of the station. The electric cable is preferably connected to an electrical network, this for example being a regional or national mains electrical network. As a variant, this may be an independent local network comprising, for example, one or more batteries powered by energy sources such as wind turbines, solar panels, fuel cells or hydroelectric generators.

In all of the foregoing, the charging station may comprise a housing inside which the wall is positioned, this wall being produced notably as a single piece with the housing.

In all of the foregoing, the clamping collar may be made of plastic, notably of fibre-reinforced polypropylene, notably glass-fibre-reinforced polypropylene. The material of the clamping collar may have a tensile Young's modulus of 8700 MPa.

In all of the foregoing, the clamping collar may be produced as a single piece. In that case, the fixing zones and the portion in the form of a broken line belong to the one same single piece.

In all of the foregoing, the charging station may be configured to supply the vehicle with an electrical power of between 7 kW and 22 kW. The transfer of electrical energy between the charging station and the vehicle may be reversible, it being possible where applicable for the vehicle to supply electrical energy to the station and therefore to the electrical network connected thereto.

In all of the foregoing, the charging station may be configured to exchange electrical energy with more than one vehicle simultaneously, for example with two vehicles. The station then has two distinct connectors, each of these connectors allowing an exchange of electrical energy with one respective vehicle.

The station may be configured to communicate with a wireless data network.

A further subject of the invention, according to another of the aspects thereof, is a method for clamping an electrical cable to a wall of a charging station for an electric or hybrid vehicle, the method comprising the following steps:

using a clamping collar having a shape that allows there to be, in a plane perpendicular to the direction of the cable, at least three points of contact between the cable and the assembly formed by the clamping collar and the wall, and

fixing the clamping collar to the wall after having positioned it in such a way that said three points of contact with the cable are present, so as to clamp the cable to the wall.

All or some of what has been set out hereinabove also applies to this other aspect.

More specifically, according to this method:

the clamping collar may interact with the cable via a portion which, in said plane perpendicular to the direction in which the cable extends, has the form of a broken line, this portion in the form of a broken line comprising at least three vertices, namely successively a first vertex, a second vertex and a third vertex, the second vertex constituting a turning point for the portion in the form of a broken line, and

the portion in the form of a broken line may be positioned in such a way that the first vertex and the third vertex are at a distance from the cable that is greater than the distance between the second vertex and the cable, or in such a way that the first vertex and the third vertex are at a distance from the cable that is smaller than the distance between the second vertex and the cable.

This method may make it possible, using the one same clamping collar, to clamp to the wall a plurality of diameters of cable, for example any single-phase or three-phase cable the diameter of which is comprised between 5 mm and 30 mm, notably between 10 mm and 22 mm, notably between 10 mm and 19 mm

The invention will be able to be better understood from reading the following description of a non-limiting embodiment thereof and from examining the appended drawing, in which:

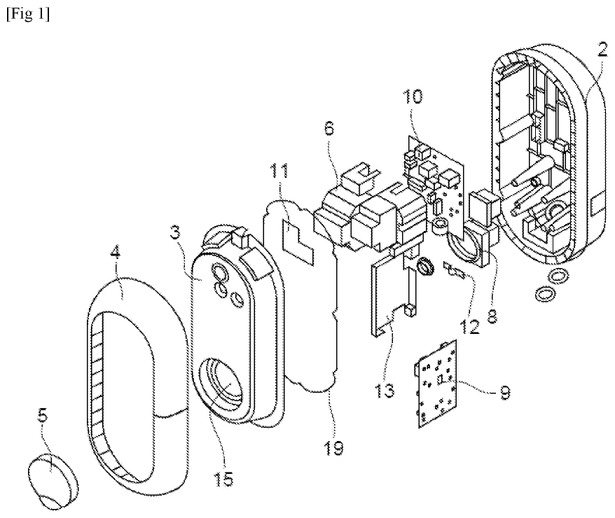

FIG. 1 depicts an exploded view of a charging station according to an exemplary embodiment of the invention, and

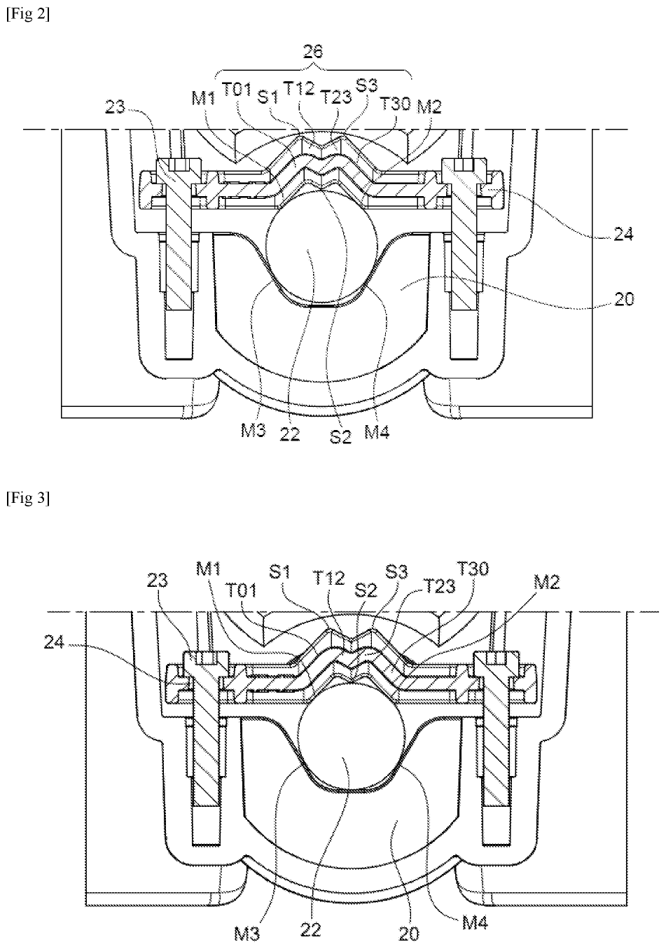

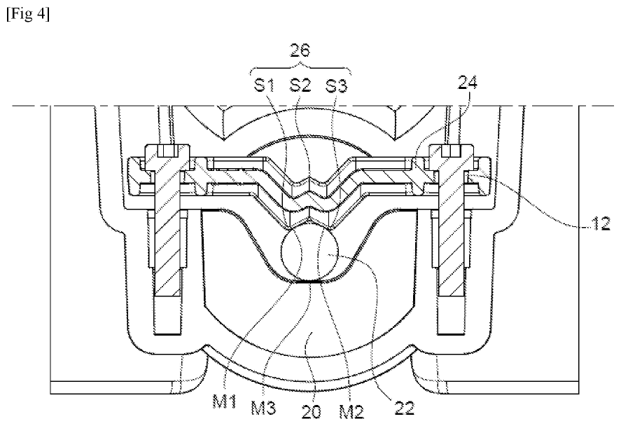

FIG. 2, FIG. 3 and FIG. 4 depict the clamping of different diameters of cable to the wall of the housing.

FIG. 1 depicts a charging station 1 according to one exemplary embodiment of the invention. This station 1 is intended to allow an exchange of electrical energy between a vehicle and an electrical network to which this station is connected via a cable 22 which has not been depicted in this FIG. 1. The vehicle can be a hybrid vehicle or an electric vehicle. The electrical network is for example a national mains network carrying an AC voltage with an effective value of 230V and a frequency of 50 Hz. This voltage may be three-phase.

The station 1 in the example considered comprises a housing formed by the combination of a back frame 2 and of a front frame 3 which are assembled with one another. A cover 4 is mounted on the periphery of the front frame 3, forming part of the front face of the station 1, which is to say the face thereof that faces towards the vehicle. A gasket 19 is interposed between the front frame 3 and the rear frame 2 to ensure sealing inside the station housing.

The station 1 also comprises a flap 5 which selectively closes off an opening 15 formed in the front frame 3. This opening 15 allows an external connector, mounted on a cable connecting to the electrical circuit of the vehicle, to be introduced into the station 1.

The station 1 also comprises a connector 8 that may be of the female type, such as a receptacle, or of the male type, such as a plug. This connector 8 may be a three-phase connector, in which case it comprises four electrical contacts, or may be a single-phase connector, in which case it comprises two contacts.

The station 1 also comprises a support 13 bearing:

a contactor 7, able to selectively interrupt the exchange of electrical energy with the vehicle, and

a meter 6 for measuring the quantity of electrical energy exchanged between the station 1 and the vehicle. This meter 6 is, for example, produced in such a way as to meet the requirements of the MID Directive (Directive 2014/32/EU).

The support 13 may be made of plastic, fibre-reinforced where applicable. The support is, for example, made of glass-fibre-reinforced polypropylene

The station in the example considered further comprises several electronic boards.

One of these boards is a power electronics board 10 bearing electronic components such as inductors or capacitors in order notably to perform a filtering function. Further functions may be performed by this board 10, for example complimentary functions such as converting voltage to power low-voltage components, or else a fuse function.

Another electronic board is a control electronics board 9, this board controlling the power electronics board 10. It may also manage any connection that the station 1 might make with a wireless data network and/or connections with the vehicle. This board may also operate a human/machine interface electronics board 11.

The human/machine interface electronics board 11 bears, for example, a luminous indicator such as an LED that informs the user as to the availability or operational status of the station 1, as well as potentially an RFID function or a button that can be actuated by the user.

The electronic boards 9 and 10 are for example screwed to the support 13, while the electronic board 11 is mounted directly on the front frame 3 of the station.

The station 1 further comprises a clamping collar 12 enabling the cable 22, which is not depicted in FIG. 1, and which is connected to the electrical network, to be held in place on the rear frame 3.

According to the invention, the one same clamping collar 12 can indifferently clamp the cable 22 of a plurality of different diameters to a wall 20 of the rear frame 3. For example, any type of cable, whether it be single-phase or three-phase, of a diameter comprised between 10 mm and 22 mm, notably between 10 mm and 19 mm, can be clamped to the wall 20 using the one same clamping collar 12.

The clamping collar 12 in the examples considered is made of plastic, notably of fibre-reinforced polypropylene. It is, for example, PPCompound H1030 marketed by Sabic®.

The wall 20 here has a curved shape to collaborate with the circular contour of the cable 22. The wall 20 in the example considered is produced as one piece with the rear frame 3.

As can be seen in FIGS. 2 to 4, the clamping collar 12 is fixed to the wall 20 via at least two fastening members 23 which in this instance are screws.

Each fastening member 23 collaborates with a fixing zone 24 of the clamping collar. In a plane perpendicular to the direction in which the cable 22 extends, which is the plane of FIGS. 2 to 4, it may be seen that these two fixing zones 24 flank a portion 26 of the clamping collar that is in the form of a broken line.

This portion in the form of a broken line here comprises three vertices S1, S2 and S3, and four segments, respectively referenced T01, T12, T23 and T30, as can be seen in FIGS. 2 to 4. It may be seen that the second vertex S2 constitutes a turning point for the portion in the form of a broken line 26. In other words, depending on the viewpoint, this portion in the form of a broken line 26 is either M-shaped or W-shaped in the plane of FIGS. 2 to 4.

The clamping collar 12 is positioned differently according to the diameter of the cable 22 so as to ensure that, irrespective of the diameter of the cable 22, there are at least three points of contact between the cable 22 and the assembly formed by the clamping collar 12 and the wall 20, so as to ensure robust clamping of the cable 22 to the wall 20.

In the example of FIG. 2, the electric cable 22 is a three-phase cable and the clamping collar 12 is positioned in such a way that the first vertex S1 and the third vertex S3 are at a distance from the cable 22 that is greater than the distance between the second vertex S2 and the cable 22. Two points M1 and M2 of contact between the cable 22 and the assembly formed by the clamping collar 12 and the wall 20 are defined here by the segment T01 and by the segment T30, respectively. Two other points of contact, M3 and M4, are in this example likewise defined by the wall 20.

In the example of FIG. 3, the electric cable 22 has a diameter smaller than that of FIG. 2. This is, for example, a single-phase cable or a three-phase cable carrying a lower electrical power than that of the example of FIG. 2. The orientation of the portion in the form of a broken line 26 is similar to that of FIG. 2, the vertex S2 still being closer to the cable 22 than the vertices S1 and S3 are. In this example, two points of contact, M1 and M2, similar to those of FIG. 2 are defined by the clamping collar 12. Two other points of contact, M3 and M4, are in this example likewise defined by the wall 20.

In the example of FIG. 4, the electric cable 22 still has a diameter smaller than that of FIG. 3. In this instance it is a single-phase cable. The orientation of the portion in the form of a broken line 26 is the opposite of that of FIGS. 2 and 3. It may be seen in FIG. 4 that the vertex S2 this time is further away from the cable 22 than the vertices S1 and S3 are. Two points M1 and M2 of contact between the cable 22 and the assembly formed by the clamping collar 12 and the wall 20 are defined here by the segment T12 and by the segment T23, respectively. A third point of contact, M3, is in this example defined by the wall 20.

It may thus be seen that, in all the examples described hereinabove, at least three points of contact between the cable 22 and the assembly formed by the clamping collar 12 and the wall 20 are achieved, it even being possible to achieve four points of contact. This then ensures robust clamping of the cable 22 to the wall.

1. Charging station for an electric or hybrid vehicle, comprising:
a wall,
an electric cable, and
at least one clamping collar fixed to the wall, wherein
the clamping collar has a shape that allows there to be, in a plane perpendicular to the direction in which the cable extends, at least three points of contact between the cable and the assembly formed by the clamping collar and the wall, so as to clamp the cable against the wall, the clamping collar interacting with the cable via a portion which, in said plane perpendicular to the direction in which the cable extends, has the form of a broken line, this portion in the form of a broken line forming at least one of the points of contact, notably two of the points of contact between the cable and the assembly formed by the clamping collar and the wall.

2. Charging station according to claim 1, the wall having a curved surface for contact with the cable and the contour of the cable being, in said plane perpendicular to the direction in which it extends, a circle.

3. Charging station according to claim 1, the portion in the form of a broken line comprising at least three vertices, namely successively a first vertex, a second vertex and a third vertex, the second vertex constituting a turning point for the portion in the form of a broken line.

4. Charging station according to claim 3, the clamping collar being positioned on the wall in such a way that the first vertex and the third vertex are at a distance from the cable that is greater than the distance between the second vertex and the cable.

5. Charging station according to claim 3, the clamping collar being positioned on the wall in such a way that the first vertex and the third vertex are at a distance from the cable that is smaller than the distance between the second vertex and the cable.

6. Charging station according to claim 1, the clamping collar being fixed to the wall via at least two fastening members, each fastening member collaborating with a fixing zone of the clamping collar and, in said plane perpendicular to the direction in which the cable extends, the portion in the form of a broken line being positioned between the two fixing zones.

7. Charging station according to claim 1, the electric cable being a three-phase or single-phase cable.

8. Charging station according to claim 1, comprising a housing inside which the wall is positioned, this wall being produced as a single piece with the housing.

9. Charging station according to claim 1, the clamping collar being made of plastic, notably of fibre-reinforced polypropylene, notably glass-fibre-reinforced polypropylene.

10. Charging station according to claim 1, being configured to supply the vehicle with an electrical power of between 7 kW and 22 kW.

11. Method for clamping an electrical cable to a wall of a charging station for an electric or hybrid vehicle, the method comprising the following steps:
using a clamping collar having a shape that allows there to be, in a plane perpendicular to the direction of the cable, at least three points of contact between the cable and the assembly formed by the clamping collar and the wall, and
fixing the clamping collar to the wall after having positioned it in such a way that said three points of contact with the cable are present, so as to clamp the cable to the wall,
in which method:
the clamping collar interacts with the cable via a portion which, in said plane perpendicular to the direction in which the cable extends, has the form of a broken line, this portion in the form of a broken line comprising at least three vertices, namely successively a first vertex, a second vertex and a third vertex, the second vertex constituting a turning point for the portion in the form of a broken line, and
the portion in the form of a broken line is positioned in such a way that the first vertex and the third vertex are at a distance from the cable that is greater than the distance between the second vertex and the cable, or in such a way that the first vertex and the third vertex are at a distance from the cable that is smaller than the distance between the second vertex and the cable.

12. Charging station according to claim 1, the portion in the form of a broken line comprising at least three vertices, namely successively a first vertex, a second vertex and a third vertex, the second vertex constituting a turning point for the portion in the form of a broken line.

13. Charging station according to claim 2, the clamping collar being fixed to the wall via at least two fastening members, each fastening member collaborating with a fixing zone of the clamping collar and, in said plane perpendicular to the direction in which the cable extends, the portion in the form of a broken line being positioned between the two fixing zones.

14. Charging station according to claim 2, the electric cable being a three-phase or single-phase cable.

15. Charging station according to claim 2, comprising a housing inside which the wall is positioned, this wall being produced as a single piece with the housing.

16. Charging station according to claim 2, the clamping collar being made of plastic, notably of fibre-reinforced polypropylene, notably glass-fibre-reinforced polypropylene.

17. Charging station according to claim 2, being configured to supply the vehicle with an electrical power of between 7 kW and 22 kW.

18. Charging station according to claim 3, the clamping collar being fixed to the wall via at least two fastening members, each fastening member collaborating with a fixing zone of the clamping collar and, in said plane perpendicular to the direction in which the cable extends, the portion in the form of a broken line being positioned between the two fixing zones.

19. Charging station according to claim 3, the electric cable being a three-phase or single-phase cable.

20. Charging station according to claim 3, comprising a housing inside which the wall is positioned, this wall being produced as a single piece with the housing.
